(19) United States
(12) Patent Application Publication
(10) Pub. No.: US 2025/0297625 A1
(43) Pub. Date: Sep. 25, 2025

(54) TRANSFORMABLE MULTIMATERIAL STRUCTURE OR OBJECT BASED ON ACTIVE MATERIALS AND METHOD FOR 4D PRINTING BY VOLUME STITCHING

(71) Applicants: CENTRE NATIONAL DE LA RECHERCHE SCIENTIFIQUE, Paris (FR); UNIVERSITE DE TECHNOLOGIE DE BELFORT-MONTBELIARD, Belfort (FR)

(72) Inventors: Frédéric DEMOLY, Dorans (FR); Jean-Claude ANDRE, Nancy (FR); Romaric PROD'HON, Granges-le-Bourg (FR)

(21) Appl. No.: 18/862,864

(22) PCT Filed: May 18, 2023
(86) PCT No.: PCT/EP2023/063445

§ 371 Date: Nov. 4, 2024

(30) Foreign Application Priority Data
May 19, 2022 (FR) FR2204779

(51) Int. Cl. F16B 1/00; A63H 33/06; B33Y 80/00

(52) U.S. Cl. CPC F16B 1/00; A63H 33/06; B33Y 80/00

(57) ABSTRACT

A three-dimensional transformable structure containing a set of individual elementary components, so-called IECs, forming a single-piece assembly. An IEC includes an active or inert material and at least one portion of the set of IECs includes at least three connecting means. Each connecting means of a considered IEC is arranged to cooperate with at least one connecting means of an IEC adjacent to the considered IEC to connect the considered IEC to the adjacent IEC. For the at least one portion of the set of IECs, at least one of the connecting means of a given IEC is located on a side opposite to at least another one of the connecting means of the considered IEC. At least one portion of the set of IECs includes so-called “active” IECs spatially arranged in the transformable structure so that at least one property of the transformable structure is modified in response to the application of at least one stimulus.

### TECHNICAL FIELD

The present invention relates to the technical field of four-dimensional printing, so-called 4D printing. This technique is based on making three-dimensional objects, so-called 3D objects, by adding material. The so-called 4D objects are then capable of changing shape or functionality over time once stimulated.

### PRIOR ART

4D printing technology is known from the prior art. 4D printing is restricted to printing of a 4D object based on one single active material under an external stimulation, making the structure soft and barely prone to withstand high mechanical stresses.

The used materials are known as smart or active materials. Smart or active materials are adaptive and/or evolutive materials as one or more of their properties can be modified by application of an energy stimulus.

Nonetheless, when it comes to multi-material objects or structures, current manufacturing techniques use materials printed by the same additive manufacturing process and materials having almost similar properties. To take account of the desire to make objects composed of similar and dissimilar materials, several additive manufacturing processes should be used and therefore this technique should be treated as a technique of assembling pre-fabricated heterogeneous elements. The use of glues or adhesive interfaces for securing elements seems to be obvious. When wrongly selected, these glues might constitute a brake, because they might limit the durability of the assemblies. Furthermore, glues have a role in controlling the desired changes in the shape of the assemblies. Glues also do not allow using all types of potentially usable materials. Finally, the gluing process could be irreversible and prevent the disassembly and the recovery/reuse of the pre-fabricated elements individually.

Dismountable mechanical connections are also known in the prior art. Nonetheless, these connections have the problem of an unachievable application on pre-fabricated elements intended to have isotropic behaviours.

In particular, the invention aims to:
provide transformable objects or structures composed or containing at least one smart or active material, i.e. which could comprise metallic/ceramic materials, preferably metallic/ceramic individual pre-fabricated elements, and polymer materials, preferably individual pre-fabricated elements made of polymer, and/or
provide transformable objects or structures composed of an active or smart material whose shape and/or other physical and/or chemical properties can be modified by application of an energy stimulus, and/or
provide transformable objects or structures composed of a smart material the modification of the shape and/or other physical and/or chemical properties of which are improved and/or controlled by application of the at least one stimulus, and/or
provide a method for manufacturing a transformable object or structure by assembling individual pre-fabricated elements, and/or
provide a versatile transformable object or structure whose structure could be modified at any time, and/or
provide an easily recyclable transformable object or structure, and/or
provide a transformable object or structure the prefabricated elements of which could be disassembled individually without being degraded or deteriorated thereby enabling use thereof again.

### DISCLOSURE OF THE INVENTION

To this end, a three-dimensional transformable structure or object, so-called transformable structure, is provided comprising a set of individual elementary components, so-called IECs or voxels, forming a one-piece assembly. An IEC, preferably each of the IECs, is preferably made of an active or inert material. At least one portion of the set of IECs comprises at least three connecting means. Each connecting means of a considered IEC is arranged so as to cooperate with at least one connecting means of an IEC adjacent to the considered IEC so as to connect, preferably reversibly, the considered IEC to the adjacent IEC, preferably so as to connect the considered IEC to the IECs adjacent to the latter. For at least one portion of the set of IECs, preferably for each IEC, at least one of the connecting means of a considered IEC is preferably located on a side opposite to at least another one of the connecting means of the considered IEC. The at least one portion of the IECs of the set of IECs comprises so-called active IECs spatially arranged, preferably in a specific and/or predetermined manner, in the transformable structure so that at least one property of the transformable structure is modified in response to the application of at least one stimulus, preferably over all or part of the structure.

The IECs may have varied sizes, advantageously identical. Advantageously, the IECs may be cubic shaped.

A connecting means may be a mechanical, physical and/or chemical connecting means.

The transformable structure may be defined as a smart object or structure.

Preferably, the at least one stimulus is an energy stimulus.

Preferably, according to the invention, by three-dimensional transformable structure, it should be understood a structure able and/or arranged to modify one or more of its geometric, physical, mechanical and/or chemical properties in response to the application of one or more external stimulus or stimuli.

Preferably, the transformable structure is able and/or arranged to perform a transformation function in response to the application of one or more external stimulus or stimuli.

Preferably, the transformable structure is able and/or arranged to modify its shape and/or its geometry in response to the application of one or more external stimulus or stimuli.

Preferably, the convertible structure according to the invention is arranged so as to be disassembled or dismounted entirely or partly without its structure and/or its properties being degraded or deteriorated.

By connecting, it could be understood joining, uniting, associating, holding, reuniting, assembling, linking, attaching, interlocking or fastening.

Preferably, one, several or each of the connecting means are arranged so as to connect, in a reversible manner, a considered IEC to one, several or each of the adjacent IECs.

Preferably, a connecting means or a coupling means of a considered IEC and a connecting means or a coupling means of another one of the IECs cooperating with the considered IEC may form a pair of connecting means or coupling means.

Preferably, the connecting means and/or the arrangement of the connecting means for and/or the spatial arrangement of the active IECs enable the transformable structure to undergo considerable mechanical deformations induced by at least one energy stimulus.

Preferably, the IECs forming or making up a perimeter of the transformable structure may comprise at least one connecting means and/or may be connected to at least one adjacent IEC. The IECs forming or making up a perimeter of the transformable structure may comprise at least two, preferably at least three, connecting means.

By perimeter of the transformable structure, it could be understood an outer face or an outer side of the transformable structure. The perimeter of the transformable structure may be continuous or discontinuous, i.e. it may comprise asperities and/or recesses and/or hollows and/or notches and/or grooves and/or slots and/or projections.

Preferably, the IECs of the at least one portion of the set of IECs comprising at least three connecting means correspond to the IECs not forming or making up the perimeter of the transformable structure. Still preferably, the IECs of the at least one portion of the set of IECs comprising at least three connecting means correspond to all of the IECs except for the IECs forming or making up the perimeter of the transformable structure.

The connecting elements of one IEC may be identical or different.

Preferably, each connecting means of an IEC is complementary with at least one connecting means of one, several or each of the other IECs. Still preferably, each connecting means of a considered IEC is complementary with at least one connecting means of one, several or each of the IECs adjacent to the considered IEC.

Preferably, a connecting means of a considered IEC is arranged so as to cooperate with a connecting means of an IEC adjacent to the considered IEC. Preferably, each of the connecting means of a considered IEC cooperates with at least one connecting means of a distinct adjacent IEC to the considered IEC and connects the considered IEC to the adjacent IEC.

Preferably, the arrangement of the transformable structure makes it versatile, still preferably as its geometry and/or its conformation could be modified by disassembly of a portion of the individually pre-fabricated elements, in a controlled manner. The transformable structure may be completely disassembled and the individual IECs recovered and, preferably, used again or recycled.

Preferably, each of the IECs of the transformable structure, with the exception of the IECs forming or making up the perimeter of the transformable structure, comprises at least four, preferably at least five, still preferably at least six, preferably at least eight connecting means.

Preferably, an IEC, preferably all of the IECs, is/are or consist(s) of a prefabricated element.

The set of IECs may comprise, preferably consist of, only active IECs. Preferably, the set of IECs comprises active IECs and passive IECs. By passive IECs, it could be understood IECs that are not sensitive to at least one stimulus, preferably insensitive to all stimulus types. By active IECs, it could be understood IECs sensitive to at least one stimulus. By sensitivity to at least one stimulus, it could be understood the propensity or the ability of an IEC, or a material, to modify its properties or to have its properties modified under the effect of a stimulus.

The set of IECs may comprise active IECs and passive IECs. The passive IECs may be:
arranged so as to contribute to and/or improve and/or control the modification of the at least one property of the transformable structure, for example by distributing, in a controlled manner, the mechanical stresses, induced by the deformation of the active IECs, to the entirety of the transformable structure, and/or
made of a material contributing to and/or improving and/or controlling the modification of the at least one property of the transformable structure, for example by distributing, in a controlled manner, the mechanical stresses, induced by the deformation of the active IECs, to the entirety of the transformable structure.

An active and/or passive IEC may consist of a material identical to or different from one, several or each of the material(s) making up the other active and/or passive IECs.

Preferably, the active IECs form a network arranged, preferably with respect to the passive IECs, so that the application of an energy stimulus causes the modification of at least one property of the transformable structure. More preferably, the active IECs form a network, preferably with respect to the passive IECs, arranged so that the localised application of an energy stimulus contributes to and/or improves and/or controls the modification of the at least one property of the transformable structure.

Preferably, at least one, still preferably several or each, of the connecting means is a coupling means.

Preferably, a coupling means or a connecting means comprises, preferably consists of or is formed by:
at least one projection cooperating with a recess or a hollow or a compartment, and/or
a cutout or a notch cooperating with a cutout or a notch, and/or
a cutout or a notch cooperating with at least one excrescence or a projection, and/or
at least one excrescence or a projection cooperating with at least one surface or side of an IEC.

In the present application, by projection, it could be understood an excrescence. In the present application, by hollow, it could be understood a recess or an indentation or a compartment. In the present application, by notch it could be understood a cutout.

A connecting means or a coupling means may be or may comprise a keying, a toothing or jaw, commonly so-called “Hirth joint”, a rod, a conduit, a tenon, a mortise, a groove, a tab, a halved joint, a box joint or a dovetail joint.

Preferably, a connecting means or a coupling means of a considered IEC and a connecting means or a coupling means of an IEC cooperating with the considered IEC may form a keying pair, a toothing pair or reciprocal jaws, commonly so-called “Hirth” joint, a rod-conduit pair, a tenon-mortise pair, a groove-tab pair, a halved joint, a box joint, a dovetail joint or a tenon-type toothing.

Preferably, each of the IECs comprises four or more sides and wherein at least three of the sides of each of the IECs of the at least one portion of the set of IECs comprising at least three connecting means each comprising at least one connecting means and said at least three sides of each of the IECs of the at least one portion of the set of IECs comprising at least three connecting means each connected to a side of another one of the IECs of the transformable structure by at least one connecting means

Preferably, each of the IECs comprises four sides or more. Preferably, each of at least four of the sides of each of the IECs of the at least one portion of the set of IECs comprising at least three connecting means comprises at least one connecting means. Preferably, each of the at least four sides of each of the IECs of the at least one portion of the set of IECs comprising at least three connecting means is connected to one side of another one of the IECs of the transformable structure by at least one connecting means.

By “sides”, it could be understood a continuous or discontinuous face or surface. By “sides”, it could be understood a face or surface from which a projection extends or in which a hollow is formed.

Preferably, each of the IECs further comprises at least two connecting means, still preferably at least three connecting means, still preferably four connecting means. Preferably, each connecting means of a considered IEC is arranged so as to cooperate with at least one means for connecting an adjacent IEC to the considered IEC so as to form, preferably reversibly:
a conduit for the transit of a fluid and/or of an energy and/or of a signal from the considered IEC towards the adjacent IEC, or vice versa, or
an electrical connection between the considered IEC and the adjacent IEC.

Preferably, for each IEC, at least one of the connecting means of a considered IEC is located on a side opposite to at least another one of the connecting means of the considered IEC.

Preferably, each connecting means of one IEC is complementary with at least one connecting means of one, several or each of the other IECs. Still preferably, each connecting means of a considered IEC is complementary with at least one connecting means of one, several or each of the IECs adjacent to the considered IEC.

Preferably, each connecting means of a considered IEC is arranged so as to cooperate with a connecting means of an IEC adjacent to the considered IEC so as to enable the transit of a fluid and/or of an energy and/or of a signal through the considered IEC towards, or conversely from, at least three IECs adjacent to the considered IEC.

Preferably, the at least one stimulus:
is electric, preferably a current or a voltage, and/or is a temperature variation and/or is a mechanical force or stress or pressure and/or is a compound circulating in the transformable structure or a variation in a concentration of a compound circulating in the transformable structure,
transits or flows or propagates, at least in part, in or through the transformable structure, preferably in or through the active and/or passive IECs, via the connecting means.

Preferably, the transformable structure is arranged so that the at least one stimulus transits or flows or propagates, at least in part, into or through the connecting means of the IECs.

The compound may be liquid and/or gaseous and/or solid and/or a gel. The solid compound may be in suspension in a liquid or may be a solute.

Preferably, when the at least one stimulus transits or flows into or through the transformable structure, the at least one stimulus is injected into at least one connecting means of one or more of the IECs forming or making up the perimeter of the transformable structure. Preferably, at least one connecting means of the one or more IEC(s), in which the at least one stimulus is injected, is comprised or located or arranged in an outer side or outer face of the transformable structure. Preferably, the outer side or the outer face of the transformable structure consists of or is formed by an outer side or an outer face of the IECs forming or making up the perimeter of the transformable structure.

Preferably, the at least one stimulus is preferably an energy stimulus. More preferably, the at least one stimulus, preferably in the case where at least one stimulus is external to the transformable structure or is applied to or from outside the transformable structure, is electrical, preferably a current or a voltage, and/or is an electric field and/or is a magnetic field and/or is a temperature variation and/or is an electromagnetic wave and/or is a mechanical force or stress or pressure and/or is a compound surrounding the transformable structure or a variation in a concentration of a compound surrounding the transformable structure.

In the case where the at least one stimulus is external to the transformable structure, the at least one stimulus can propagate from outside the transformable structure into or through the transformable structure.

The transformable structure may be arranged so that at least one of its properties, preferably so that at least one of the properties of at least one of the active IECs is modified in response to the application of at least one external stimulus, propagating in or through the transformable structure and/or in response to at least one stimulus transiting or flowing into or through the transformable structure via the connecting means of the IECs.

Preferably, the electromagnetic wave has one or more specific or predetermined monochromatic wavelength(s) and/or may be a range of specific or predetermined wavelengths. Preferably, the one or more monochromatic wavelength(s) or the range of electromagnetic wavelengths is comprised in the UV and/or infrared and/or visible range.

Preferably, the modification, or the change, of at least one property of the object or the transformable structure is a change in the shape and/or in the geometry and/or in the configuration and/or in the volume and/or in optical properties and/or in mechanical properties and/or in chemical properties and/or in the thermal conductivity and/or in the electrical conductivity.

By optical properties, it could be understood changes in the refractive index and/or in the polarisation and/or in the turbidity and/or in the colour.

By mechanical properties of the transformable structure or of an IEC, it could be understood a Young's modulus, a shear modulus or Poisson's ratio. Preferably, the transformable structure has a Young's modulus comprised between 10 and 10⁷ Pascal.

Preferably, the IECs comprise or consist of a polymer and/or a metal and/or a ceramic and/or a gel, preferably viscoelastic, and/or a piezoelectric material and/or a shape-memory material.

According to the invention, a method for manufacturing a single-piece three-dimensional transformable structure, preferably the transformable structure according to the invention, is also provided. The method comprises the step of providing a set of individual elementary components, so-called IECs, an IEC comprising an active or inert material. At least one portion of the IECs of the set of IECs comprises at least three connecting means. For the at least one portion of the IECs of the set of IECs, at least one of the connecting means of a considered IEC is preferably located on a side opposite to at least another one of the connecting means of the considered IEC and at least one portion of the set of IECs comprises so-called active IECs.

The manufacturing method further comprises the step of assembling, via a robotic system, preferably reversibly, the IECs of the set by successively interlocking at least one connecting means of one IEC with at least one connecting means of another one of the IECs and spatially arranging, preferably in a specific and/or predetermined manner, the active IECs in the assembly, preferably in the transformable structure, the IECs being preferably obtained by additive manufacturing, so that at least one property of the transformable structure is modified in response to the application of at least one stimulus, preferably over all or part of or outside of the transformable structure.

Preferably, according to a first alternative, the step of assembling the IECs of the set, so-called the assembly step, comprises:
forming, simultaneously or subsequently, at least two distinct single-piece layers or planes of IECs, by successively interlocking at least one means for connecting an IEC with at least one means for connecting another one of the IECs, and then
assembling a formed layer with another one of the formed layers by interlocking at least one connecting means of each of the IECs of a formed layer with at least one connecting means of each of the IECs of another one of the formed layers.

Preferably, according to a second alternative, combinable with the first alternative, the step of assembling the IECs comprises:
forming, simultaneously or subsequently, at least three distinct single-piece rows of IECs, by successively interlocking at least one means for connecting one IEC with at least one means for connecting another one of the IECs, and then.
assembling a formed row with another one of the formed rows, by interlocking at least one connecting means of each of the IECs of a formed row with at least one connecting means of each of the IECs of another one of the formed rows, to form at least one single-piece layer of IECs, and then
assembling the formed layer with another formed row or, respectively, with another one of the formed layers by interlocking at least one connecting means of each of the IECs of a formed layer with at least one connecting means of each IECs of another formed row or, respectively, with at least one connecting means of each of the IECs of another one of the formed layers.

Multi-material 4D printing allows composing dissimilar objects or structures, at least one of which is active. This offers greater freedom to distribute space and time behaviours but also to integrate the energy stimulation at the core of the object or structure. The present invention relates to multi-material 4D printing of transformable objects or structures in a volume-by-volume building strategy, which consists of the assembly of pre-fabricated elements so-called voxels or IECs (thereby the name additive manufacturing). These voxels are made of materials allowing changing the shape and/or a property of the 4D objects under the action of an energy stimulation which could be external and/or internal.

In the present application, unless indicated otherwise or incompatible, the described features apply to the first and second alternatives of the method.

By “associate”, it could be understood join or connect or reunite or attach.

By “interlock”, it could be understood embed or fit or nest or couple or engage or insert.

Preferably, the robotic system comprises an articulated arm. Preferably, the robotic system, preferably the articulated arm, is able and/or arranged to move the IECs according to three axes, more preferably according to six axes. Preferably, the articulated arm is a so-called six-axis arm.

The robotic system may be able and/or arranged to move.

The robotic system may be coupled or may comprise optical means or shape-recognition systems for guiding and/or controlling and/or assisting the robotic system during assembly.

Preferably, the manufacturing method comprises the step of forming and assembling a row or a layer of IECs over a paving. Preferably, the paving comprises a set of receiving sites and each receiving site comprises at least one reversible connecting means arranged so as to cooperate with at least one connecting means of at least one IEC. Preferably, the step of forming and assembling the row or the layer of IECs over the paving consists in interlocking at least one connecting means of each of the IECs of the row or layer with at least one reversible connecting means of a different receiving site.

According to the first alternative, the step of forming and assembling a row of IECs over the paving may comprise or consist in forming and depositing a first row of IECs of the transformable structure over which and/or from which one or more other row(s) of IECs will be deposited.

The step of forming and assembling a layer of IECs over the paving may consist in forming and depositing a first layer of IECs of the transformable structure over which one or more other layers of IECs will be deposited or over which and/or from which all of the other layers of the transformable structure will be deposited.

Preferably, the step of assembling the IECs according to the first and second alternatives comprises the step of forming and assembling a row or a layer of IECs over a paving.

Preferably, the step of depositing and assembling a first row or a first layer of IECs over the paving is part of or is comprised in the step of forming at least two distinct single-piece layers of IECs according to the first and second alternatives and/or the step of forming at least three distinct one-piece rows of IECs according to the second alternative and/or the step of assembling a formed row or, respectively, a layer with another one of the formed layers or, respectively, with another one of the formed rows according to the second alternative.

Preferably, the paving is intended to serve as a reference frame for the robotic system and/or has the effect of stabilising the assembly during manufacture.

Preferably, each connecting means of each receiving site of the paving is complementary with at least one connecting means of one, several or each of the IECs.

The step of forming and assembling a row or a layer of IECs over a paving may comprise using one or more paving(s).

Preferably, the manufacturing method comprises the step of individually storing the IECs temporarily, per row, per layer, by set or subset and, during the assembly of the IECs and/or prior to the assembly of the IECs, preferably prior to the step of assembling the IECs together with or without paving, over the paving.

Preferably, each of the IECs stored over the paving is neither assembled nor connected to any other one of the stored IECs.

The step of storing the IECs may comprise using one or more paving(s) which may be identical to or different from the pavings used for the step of forming and assembling a row or a layer of IECs over a paving. One or more of the pavings may be an area dedicated to storage of the IECs.

Preferably, the manufacturing method comprises the step of handling and transporting the IECs by the robotic system. Preferably, the step of handling and transporting further comprises coupling, successively and reversibly, at least one connecting means of an IEC with at least one reversible coupling means of the robotic system.

Preferably, the articulated arm of the robotic system comprises the coupling means.

Preferably, the manufacturing method comprises a step of disassembling all or part of the IECs composing the single-piece transformable structure manufactured or being manufactured or all or part of a row and/or of a layer of IECs by separating a considered IEC from one or more of the adjacent IECs with which the considered IEC is connected by disengaging the one or more connecting mean(s) of the considered IEC from the one or more connecting mean(s) of the adjacent IECs with which the one or more connecting mean(s) of the considered IEC cooperate by interlocking, or wherein the one or more connecting means of the considered IEC are reciprocally interlocked.

Preferably, the disassembly is implemented by the robotic system.

The manufacturing method may comprise one or more step(s) of manufacturing all or part of the IECs of the set of IECs. The step of manufacturing all or part of the IECs may result from additive, or subtractive, or formative manufacturing processes. The manufacturing step may be part or may consist of the step of providing the set of IECs.

Preferably, the manufacturing method comprises the step of:
selecting, in a database or a storage:
   one or more individual IECs having different spatial conformations and/or comprising or consisting of different materials, and/or
   one or more subset(s) of IECs among subsets of IECs having different spatial conformations and/or subsets of IECs comprising or consisting of different materials. Preferably, the manufacturing method comprises the step of determining, from the selected individual IECs or the selected subsets, one or more arrangement(s) of the subsets with respect to one another in the transformable structure so that the application of at least one stimulus results in the modification of at least one property of the transformable structure.

The method according to the invention is particularly suitable, still preferably specially designed, to implement the device according to the invention. Thus, any feature of the method according to the invention may be integrated into the device according to the invention and vice versa.

### DESCRIPTION OF THE FIGURES

Other advantages and particularities of the invention will appear upon reading the detailed description of non-limiting implementations and embodiments, and from the following appended drawings:

FIG. 1 is a schematic illustration of embodiments of three-dimensional transformable structures according to the invention illustrating the modification of the three-dimensional conformation of the transformable structures in response to the application of a stimulus,

FIG. 2 is a schematic illustration of embodiments of three-dimensional transformable structures according to the invention illustrating examples of spatial distributions of active voxels and of passive voxels within transformable structures,

FIG. 3 is a schematic illustration of two embodiments of three-dimensional transformable structures according to the invention illustrating examples of different spatial distributions of active voxels and of passive voxels within transformable structures,

FIG. 4 is a schematic illustration of the two three-dimensional transformable structures of FIG. 3 each having a different arrangement of active voxels and of passive voxels illustrating the modification of the three-dimensional conformation of the transformable structures in response to the application of a stimulus,

FIG. 5 is a schematic illustration of an embodiment of voxels and of their coupling means,

FIG. 6 is a schematic illustration of an embodiment of voxels and of their coupling means,

FIG. 7 is a schematic illustration of the principle of a method for manufacturing three-dimensional transformable structures according to the invention,

FIG. 8 is a schematic illustration of an embodiment of a means used for the implementation of the method for manufacturing three-dimensional transformable structures according to the invention,

FIG. 9 is a schematic illustration of a voxel assembly mode that could be used for the implementation of the method for manufacturing three-dimensional transformable structures according to the invention.

### DESCRIPTION OF THE EMBODIMENTS

The embodiments described hereinafter being in no way restrictive, variants of the invention comprising only a selection of the described features, isolated from the other described features (even though this selection is isolated within a sentence comprising these other features) could be considered in particular, if this selection of features is sufficient to confer a technical advantage or to differentiate the invention with regards to the prior art. This selection comprises at least one feature, preferably a functional feature with no structural details, or with only part of the structural details if this portion alone is sufficient to confer a technical advantage or to differentiate the invention with regards to the prior art.

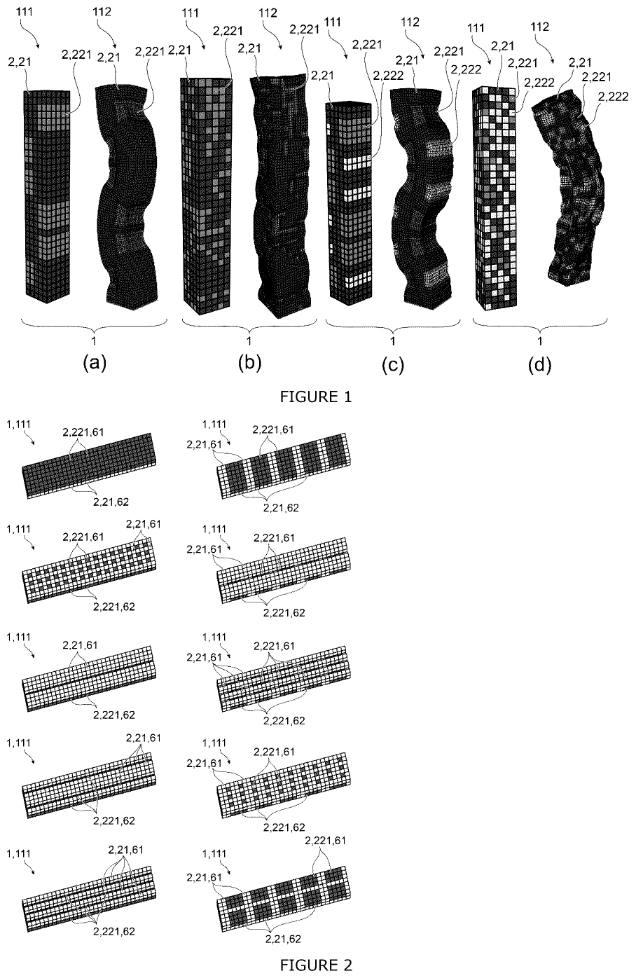

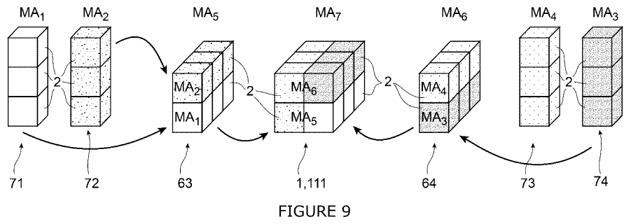

Referring to FIGS. 1 to 9, an embodiment of the invention is described.

According to the embodiment, and with reference to FIGS. 1 to 3 and 6, three-dimensional transformable structures 1, so-called the structures 1, according to the invention are depicted. These structures 1 comprise a set of individual elementary components 2, so-called IECs 2, forming a single-piece set. The IECs 2 consist either of an active material or of an inert material. The IECs 2 made of an active material are active IECs 221 and the IECs 2 made of an inert material are passive IECs 21. FIGS. 1, 3 and 4 are schematic illustrations obtained by simulations. According to the non-limiting embodiment, the simulation has been obtained by using Euler-Bernoulli beam calculation and/or by coupling the results of this calculation with genetic algorithms.

According to the embodiment, and with reference to the structures (c) and (d) of FIG. 1, the structure 1 further comprises space areas 222 or voxels 222 empty or comprising no IECs 2. The structure 1 may comprise only active IECs 221. Nonetheless, structures 1 having particularly interesting properties may be obtained by combining, according to a suitable spatial arrangement, within the structure 1, voxels 222 comprising no IECs 2, or voxels comprising active IECs 221, and passive IECs 21, or voxels comprising passive IECs.

The voxels 222 comprising no IECs 2, the active IECs 221 and the passive IECs 21 are spatially arranged specifically in the structure 1 so that at least one property of the structure 1 is modified in response to the application of at least one stimulus.

As non-limiting examples, the active IECs 221 may, as non-limiting examples, shape-memory polymers, shape-memory alloys, electroactive polymers, liquid-crystal elastomers, hydrogels or piezoelectric materials. As non-limiting examples, the passive IECs 21 may be polymers, such as elastomers, metal alloys, ceramics, glasses.

The IECs 2 allow paving the 3D space. They may have any shape and any size. For example, the IECs 2 may have a spherical, cylindrical, ovoid, prismatic, conical, pyramidal shape. For example, the IECs 2 may have a size comprised between 10 μm and several millimetres depending on the accuracy of the system for manufacturing the IECs 2. Typically, the IECs 2 have a size comprised between 5 mm and 1 cm.

According to the embodiment, the IECs 2 forming the structures 1 depicted in the embodiment comprise at least six connecting means 3. Apart for the IECs 2 one or more face(s) of which form an outer face of the structure 1, one, several or each connecting means 3 of one face of a considered IEC 2 is arranged so as to cooperate with one, several or each connecting means 3 present on a face of an IEC 2 adjacent to the considered IEC 2. Thus, a considered IEC 2 is connected to at least one of the IECs 2 that are adjacent thereto by one, several or each connecting means 3. According to the disclosed embodiment, apart from the IECs 2 comprising one or more face(s) forming an outer face of the structure 1, each IEC 2 of the structure 1 is connected to each of the IECs 2 that are adjacent thereto.

Preferably, the connecting means 3 are reversibly connectable. Nonetheless, the invention does not exclude a permanent connection, for example with connecting means 3 by snap-fastening, of a considered IEC 2 with one, several or each of the IECs 2 adjacent thereto.

According to the disclosed non-limiting embodiment, for each IEC 2, at least one of the connecting means 3 of a considered IEC 2 is located on one side of the considered IEC 2 which is opposite to one side of the considered IEC 2 comprising at least another one of the connecting means 3.

According to the non-limiting embodiments illustrated in FIGS. 1 to 3, the property of the structure 1 that is modified in response to the application of at least one stimulus is the conformation or the spatial configuration of the structure 1. According to the embodiment, the active IECs 221 are hydrogels, the voxels 222 are simulated by extremely passive materials to best match empty space areas and the passive IECs 21 are flexible polymers or elastomers, for example as listed before. The structure 1 has a rectilinear conformation 111 in the absence of any stimulus. Upon application of the stimulus, the structure 1 deforms to adopt a predetermined non-rectilinear conformation 112. It is possible to spatially arrange the active IECs 221 with respect to one another, the voxels 222 comprising no IECs 2 with respect to the active IECs 221 and/or to the passive IECs 21 and the passive IECs 21 with respect to the active IECs 221 and/or with respect to the voxels 222 comprising no IECs 2 so that the structure deforms according to several directions and/or according to several modes of deformation in order to result in a desired or particular conformation 112 upon application of the stimulus. Referring to FIG. 1, the structures 1 (a) and (c) are, for example, structures 1 derived from a database. According to the non-limiting embodiment illustrated in FIG. 1, The active IECs 221 are composed of a hydrogel and the passive IECs 21 are composed of an elastomer, the transformation of which is done under the effect of a thermal stimulation in an aqueous medium. For example, it would also be possible to use active IECs 221 composed of liquid crystal elastomers or shape-memory polymers and to cause a similar deformation under the effect of a thermal stimulation. Also, depending on the structures 1 (a) and (c), one could observe a series of bends along the structure 1 so that the conformation 112 adopted upon stimulation has a series of curves and the structure 1 has a serpentine-type shape 112. According to the invention, it is proposed to modify the spatial arrangement or the conformation of the voxels 222, of the active IECs 221 and of the passive IECs 21, with respect to one another, and/or their number within the structure 1 derived from the database so as to obtain a better transformation and/or a different transformation of the structure 1. According to the non-limiting embodiments illustrated on the structures (b) and (d), this new configuration or arrangement of the voxels 222, of the active IECs 221 and of the passive IECs 21 within the structure 1, with respect to one another, has been calculated so as to enable additional deformations, for example torsions, along the structure, within the structure 1. The structure 1 (b) is derived from the structure 1 (a) and the structure 1 (d) is derived from the structure 1 (c).

Nonetheless, although because of its visible and illustrative nature, the modified property, according to the disclosed non-limiting embodiment, is the shape of the structure 1, other properties of the structure 1 could be modified by selecting other active and/or passive materials.

In FIG. 2, embodiments of structures 1 are illustrated each having a different spatial arrangement of different active IECs 221 and passive IECs 21. The illustrated structures 1 comprise a stack of two layers 61, 62 of IECs 2. The illustrated structures 1 have a rectilinear conformation 111 in the absence of any stimulus. The application of a stimulus will induce a deformation of the different structures 1 so that the structures 1 adopt different conformations 112.

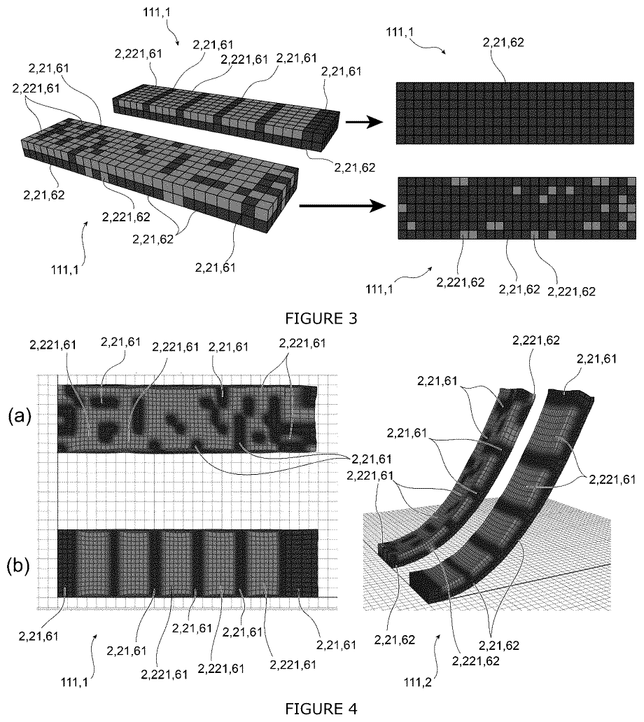

Two structures 1 are illustrated in FIG. 3 each having a spatial arrangement of different active IECs 221 and passive IECs 21. Like for FIG. 3, the illustrated two structures 1 comprise a stack of two layers 61, 62 of IECs 2 and have a rectilinear conformation 111 in the absence of any stimulus.

Referring to FIG. 4, the effect of the application of a stimulus on each of the two structures 1 depicted in FIG. 3 is illustrated. One could observe that despite the spatial arrangement of the active IECs 221 and of the passive IECs 21 substantially different between the two structures 1, the application of a stimulus results in an identical conformation 112 when a stimulus is applied. Both structures 1 bend upon application of the stimulus to adopt an identical curved shape 112.

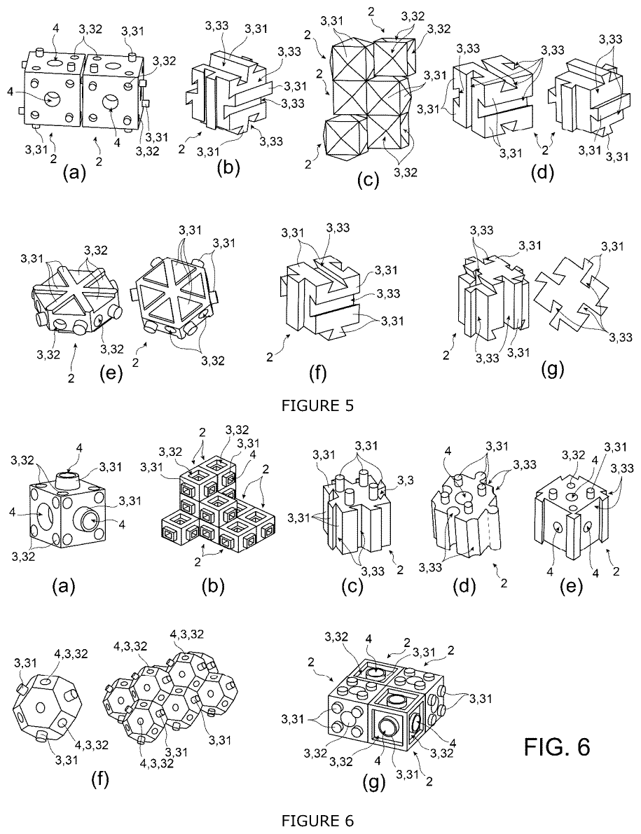

Referring to FIGS. 5 and 6, different connecting means 3 considered in the context of the invention are illustrated as non-limiting examples. These examples are not limiting but illustrative. According to the embodiment, the connecting means 3 are coupling means capable of reversibly connecting one IEC 2 to another IEC 2.

A coupling means 3 according to the invention may be an excrescence 31, a projection 31, a bead 31, a recess 32, a hollow 32, a compartment 32, a cutout 33 or a notch 33. One face of an IEC 2 may comprise one or more coupling means 3. One face of an IEC 2 may have the same coupling means 3, i.e. one single type of coupling means 3. According to the invention, two opposite sides, or two opposite faces, of an IEC 2 may be, yet not necessarily, parallel to one another. One, several or each face of a considered IEC 2 may have same coupling means 3 different from one, several or each coupling means 3 of one, several or each of the other faces of the considered IEC 2. One, several or each coupling means 3 of a considered IEC 2 may be different from one, several or each coupling means 3 of one, several or each of the IECs 2 adjacent to the considered IEC 2.

The IECs 2 may also comprise a conduit 4 for the transit of a fluid from a considered IEC 2 towards an adjacent IEC 2 and vice versa. The IECs 2 (a) of FIG. 5 and (a), (b), (d), (e), (f) and (g) of FIG. 6, comprise a conduit 4 on at least two of their faces. The conduit 4 may comprise or be formed, at least partially, by an opening 4 extending into or through the wall of the IEC 2. The conduit may also comprise or be formed by a projection 3 extending beyond the wall of an IEC 2. Furthermore, the conduit 4 may also form, entirely or partly, a coupling means 3.

Referring to the IECs 2 (c), (d) and (f) of FIG. 5 and (b), (f) of FIG. 6, each face of an IEC 2 comprises one single coupling means 3, 31 or 3, 32 or 3, 33 or 4, 3, 32 per face.

Referring to the IECs 2 (a), (g), (e) of FIG. 5 and (a), (c), (d), (e) and (f) of FIG. 6, it may be considered that at least one face of the IECs 2 comprises several coupling means 3, 31 and 3, 32 or 3, 31 and 4, 3, 32 or 3, 31 and 3, 33. In this case, the coupling means 3, 31 and 3, 32 or 3, 31 and 4, 3, 32 or 3, 31 and 3, 33 of one face are arranged so as to cooperate with one, some or all of the coupling means 3 of one face of an adjacent IEC 2. Nonetheless, it may also be considered that the different coupling means 3, 31 and 3, 32 or 3, 31 and 4, 3, 32 or 3, 31 and 3, 33 of one face of the IECs 2 form one single coupling means 3. In this case, the coupling means 3, 31 and 3, 32 or 3, 31 and 4, 3, 32 or 3, 31 and 3, 33 of one face is arranged so as to cooperate with one, some or all of the coupling means 3 of one face of an adjacent IEC 2.

The one or more coupling means 3 of one face of a considered IEC 2 may be different from the one or more coupling means 3 of another face of the considered IEC 2. This allows promoting the modification of a property of the structure 1 according to a given direction, for example a deformation of the structure according to a given direction. This allows constraining, limiting or preventing the modification of a property of the structure 1 according to a given direction, for example a deformation of the structure according to a given direction.

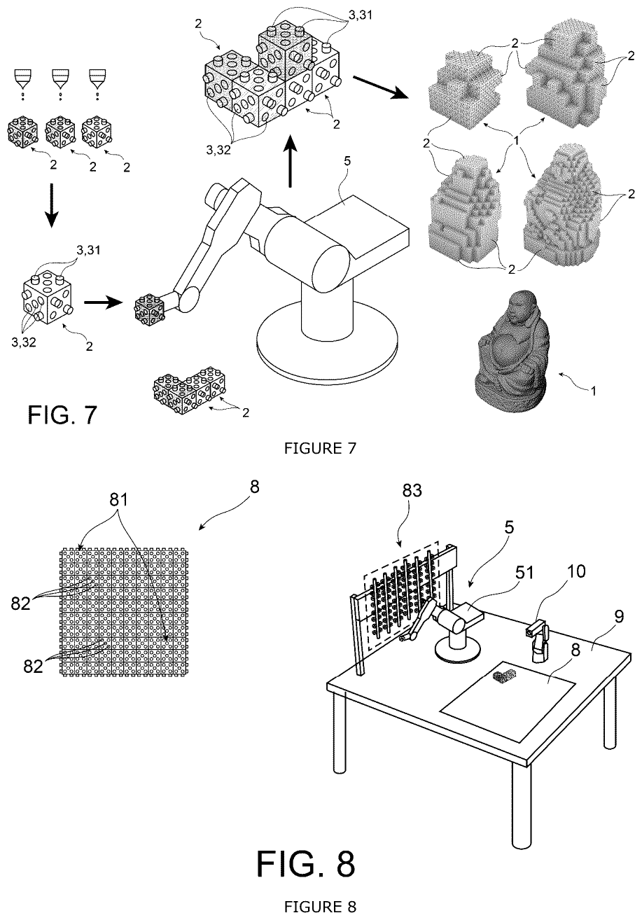

Referring to FIGS. 7 to 9, an embodiment of the method for manufacturing structures 1 according to the invention is illustrated.

Referring to FIG. 7, a schematic illustration is depicted illustrating the concept of an embodiment of the method for manufacturing structures 1 according to the invention. A first step of the method consists in providing a set of individual IECs 2 according to the invention. The IECs 2 may be obtained by any means, in particular commercially-available, without the step of designing the IECs 2 being part of the process. As non-limiting examples, the IECs may be obtained by additive methods, preferably by 3D printing, or by subtractive methods. As a non-limiting example, the obtainment of IECs 2 by 3D printing is illustrated in FIG. 7. The 3D printing of IECs made of polymer, metal and composite material is illustrated.

The method also comprises the step of assembling the IECs 2 by means of a robotic system 5. The IECs 2 are assembled by the robotic means 5 by successively interlocking at least one connecting means 3 of an IEC 2 with at least one connecting means of another one of the IECs 2. The IECs 2 are assembled so as to spatially arrange the active IECs in the structure 1 being manufactured so that at least one property of the structure 1 is modified in response to the application of at least one stimulus. The spatial arrangement is carried out so that the active IECs 221 are arranged in a predetermined manner with respect to one another, with respect to the voxels 222 comprising no IECs 2 and with respect to the passive IECs 21.

According to a non-limiting improvement, the method comprises a step of selecting, in a database, the active 221 and/or passive 21 individual IECs 2 and/or subsets of IECs 2 among subsets of IECs 2 comprising active IECs 221 and/or passive IECs 21. Starting from or concomitantly with the selection step and depending on the desired or pursued modification of at least one property of the structure 1, the method comprises a step of determining, from the selected individual IECs 2 and/or the selected subsets, one or more arrangement(s) of selected individual IECs 2 and/or of the subset of IECs 2 with respect to one another in the transformable structure 1 to be manufactured so that the application of at least one stimulus produces the desired modification of at least one desired property of the structure 1.

According to the non-limiting embodiment, the robotic means 5 is an articulated arm 5 mounted on an assembly/disassembly station 9. The articulated arm 5 comprises at its movable end a reversible coupling means 51 for grasping or fixing the IECs 2 to be assembled or disassembled. The station also comprises a paving 8. The paving 8 comprises a set of receiving sites 81. Each receiving site 81 comprises at least one reversible connecting means 82 arranged so as to cooperate with at least one connecting means 3 of each of the IECs 2 to be assembled/disassembled. The paving 8 consists of an assembly area that can also be used for temporary storage for individual IECs 2, for one or more row(s) 71, 72, 73, 74 of IECs 2 or for one or more layer(s) 61, 62, 63, 64 of IECs 2. In the case of rows 71, 72, 73, 74 of IECs 2 or of layers 61, 62, 63, 64 of IECs 2, a coupling means 3, or preferably each coupling means 3, of several ones of the IECs 2, preferably of each of the IECs 2, one or more face(s) of which form(s) an outer face of the structure 1, cooperate with a reversible connecting means 82 of a distinct receiving site 81 of the paving 8. According to the embodiment, the assembly/disassembly station 9 comprises an area 83 for storing the IECs 2 which is dedicated only to the storage of the IECs 2. This storage area 83 may also comprise a set of receiving sites 81. Each receiving site 81 comprises at least one reversible connecting means 82 arranged so as to cooperate with at least one connecting means 3 of each of the IECs 2 to be assembled/disassembled.

The manufacturing method also comprises, according to a first alternative, the step, so-called the assembly step, consisting in assembling the IECs 2 of the set, comprising forming at least two distinct single-piece layers 61, 62 of IECs 2. Forming the layers 61, 62 consists in successively interlocking at least one coupling means 3 of one IEC 2 with at least one coupling means 3 of another one of the IECs 2. Subsequently to the formation of the layers 61, 62, a formed layer 61 or 62 is assembled with another one of the formed layers 62 or 61 by interlocking at least one coupling means 3 of each of the IECs 2 of a formed layer 61, 62 with at least one coupling means 3 of each of the IECs 2 of another one of the formed layers 61, 62.

As many layers 61, 62 as necessary may be assembled. Furthermore, a layer 61, 62 may be assembled on a set of layers 61, 62 already formed or a set of layers 61, 62 already formed may be assembled with another set of layers 61, 62 already formed.

According to a second alternative, the assembly step consists in forming at least three distinct single-piece rows 71, 72, 73, 74 of IECs 2. Forming the rows 71, 72, 73, 74 consists in successively interlocking at least one coupling means 3 of one IEC 2 with at least one coupling means 3 of another one of the IECs 2. Subsequently to the formation of the rows 71, 72, 73, 74, at least one single-piece layer 63, 64 of IECs 2 is formed. Forming the layer 63, 64 consists in assembling a formed row 71, 73 with another one of the formed rows 72, 74 by interlocking at least one coupling means 3 of each of the IECs 2 of a formed row 71, 73 with at least one coupling means 3 of each of the IECs 2 of another one of the formed rows 72, 74. Subsequently to the formation of the at least one single-piece layer 63, 64, the at least one formed layer 63, 64 is assembled:
according to a first alternative, with another formed row 71, 72, or 73, 74, or
according to a second alternative, with another one of the formed layers 64, 63.

The assembly of the at least one formed layer 63, 64 with another formed row 71, 72, or 73, 74 or with another one of the formed layers 64, 63 is carried out by interlocking at least one coupling means 3 of each of the IECs 2 of the at least one formed layer 63, 64 with:
according to the first alternative, at least one coupling means 3 of each of the IECs 2 of another formed row 71, 72, or 73, 74, or
according to the second alternative, at least one coupling means 3 of each of the IECs 2 of another one of the formed layers 64, 63.

The two alternatives of the assembly step may be combined and may be implemented in parallel.

The step of forming and/or assembling the row 71, 72, 73, 74 or of the layer 61, 62, 63, 64 of IECs 2 may be carried out entirely or partly over the paving 8. The step of forming and/or assembling the row 71, 72, 73, 74 or of the layer 61, 62, 63, 64 of IECs 2 over the paving 8 consists in interlocking at least one coupling means 3 of each of the IECs 2 of the row 71, 72, 73, 74 or of a row of the layer 61, 62, 63, 64 or of the layer 61, 62, 63, 64 with at least one reversible connecting means 82 of a different receiving site 81 of the paving 8.

An advantage of the method for manufacturing the structure 1 and of the structure 1 manufactured or being manufactured is that it is possible to disassemble all or part of the IECs 2 composing the structure 1 manufactured or being manufactured or of rows 71, 72, 73, 74 of IECs 2 or of layers 61, 62, 63, 64 of IECs 2 stored or not over the paving 8. Thus, it is possible to separate or detach a considered IEC 2 from one or more of the adjacent IECs 2 with which the considered IEC 2 is connected by disengaging the one or more coupling means 3 of the considered IEC 2 cooperating by interlocking with the one or more coupling means 3 of the adjacent IECs 2 with which the considered IEC 2 is connected.

Of course, the invention is not limited to the examples that have just been described and many arrangements could be made to these examples without departing from the scope of the invention.

Thus, in variants that could be combined together of the previously-described embodiments:
for each IEC 2, a considered IEC 2 comprises an electrical connecting means 4, preferably at least three electrical connecting means 4 between the considered IEC 2 and an IEC 2 adjacent to the considered IEC 2,
the one or more coupling means 3 of one IEC 2 forms the electrical connecting means 4 of the IEC 2.

In addition, the different features, shapes, variants and embodiments of the invention may be associated with each other according to various combinations to the extent that they are not incompatible or exclusive of one another.

1. A three-dimensional transformable structure containing a set of individual elementary components, so-called IECs or voxels, forming a one-piece assembly, an IEC comprises an active or inert material, at least one portion of the set of IECs comprises at least three connecting means; each connecting means of a considered IEC is arranged so as to cooperate with at least one connecting means of an IEC adjacent to the considered IEC so as to connect the considered IEC to the adjacent IEC and, for the at least one portion of the set of IECs, at least one of the connecting means of a considered IEC is located on a side opposite to at least another one of the connecting means of the considered IEC; at least one portion of the set of IECs comprises so-called active IECs spatially arranged in the transformable structure so that at least one property of the transformable structure is modified in response to the application of at least one stimulus.

2. The three-dimensional transformable structure according to claim 1, wherein at least one of the connecting means is a coupling means.

3. The three-dimensional transformable structure according to claim 2, wherein the coupling means comprises:
at least one excrescence or a projection cooperating with a recess or a hollow or a compartment, and/or
a cutout or a notch cooperating with a cutout or a notch, and/or
a cutout or a notch cooperating with at least one excrescence or a projection, and/or
at least one excrescence or a projection cooperating with at least one surface of an IEC.

4. The three-dimensional transformable structure according to claim 1, wherein each of the IECs comprises four or more sides and wherein at least three of the sides of each of the IECs of the at least one portion of the set of IECs comprising at least three connecting means each comprising at least one connecting means and said at least three sides of each of the IECs of the at least one portion of the set of IECs comprising at least three connecting means are each connected to a side of another one of the IECs of the transformable structure by at least one connecting means.

5. The three-dimensional transformable structure according to claim 1, wherein each of the IECs further comprises at least three connecting means; each connecting means of a considered IEC is arranged so as to cooperate with at least one connecting element for connecting an adjacent IEC to the considered IEC so as to form:
a conduit for the transit of a fluid from the considered IEC towards the adjacent IEC, or vice versa, or
an electrical connection between the considered IEC and the adjacent IEC.

6. The three-dimensional transformable structure according to claim 5, wherein at least one stimulus:
is electric and/or is a temperature variation and/or is a mechanical force or stress or pressure and/or is a compound circulating in the transformable structure or a variation in a concentration of a compound circulating in the transformable structure,
transits in the transformable structure via the connecting means.

7. The three-dimensional transformable structure according to claim 1, wherein the at least one stimulus is electric and/or an electric field and/or a magnetic field and/or a temperature variation and/or an electromagnetic wave and/or a mechanical force or stress or pressure and/or a compound surrounding the transformable structure or a variation in a concentration of a compound surrounding the transformable structure.

8. The three-dimensional transformable structure according to claim 1, wherein the modification of at least one property of the transformable structure is a change in shape and/or volume and/or optical properties and/or mechanical properties and/or chemical properties and/or thermal conductivity and/or electrical conductivity.

9. The three-dimensional transformable structure according to claim 1, wherein the IECs comprise or consist of a polymer and/or a metal and/or a ceramic and/or a gel and/or a piezoelectric material and/or a shape-memory material.

10. A method for manufacturing a single-piece three-dimensional transformable structure comprising the steps of:
providing a set of individual elementary components, so-called IECs, an IEC comprising an active or inert material; at least one portion of the IECs of the set of IECs comprises at least three connecting means and, for the at least one portion of the IECs of the set of IECs, at least one of the connecting means of a considered IEC is located on a side opposite to at least another one of the connecting means of the considered IEC and at least one portion of the set of IECs comprises so-called active IECs,
assembling, via a robotic system, the IECs of the set by successively interlocking at least one connecting element for connecting an IEC with at least one connecting element for connecting another one of the IECs and spatially arranging the active IECs in the assembly so that at least one property of the three-dimensional transformable structure is modified in response to the application of at least one stimulus.

11. The method according to claim 10, wherein the step of assembling the IECs of the set, so-called the assembly step, comprises:
forming at least two distinct single-piece layers of IECs, by successively interlocking at least one connecting element for connecting an IEC with at least one connecting element for connecting another one of the IECs, and then
assembling a formed layer with another one of the formed layers by interlocking at least one connecting means of each of the IECs of a formed layer with at least one connecting means of each of the IECs of another one of the formed layers, or
forming at least three distinct single-piece rows of IECs, by successively interlocking at least one connecting element for connecting one IEC with at least one connecting element for connecting another one of the IECs, and then
assembling a formed row with another one of the formed rows, by interlocking at least one connecting means of each of the IECs of a formed row with at least one connecting means of each of the IECs of another one of the formed rows, to form at least one single-piece layer of IECs, and then
assembling the formed layer with another formed row or, respectively, with another one of the formed layers by interlocking at least one connecting means of each of the IECs of a formed layer with at least one connecting means of each IECs of another formed row or, respectively, with at least one connecting means of each of the IECs of another one of the formed layers.

12. The method according to claim 11, comprising the step of forming and assembling a row or a layer of IECs over a paving, the paving comprises a set of receiving sites and each receiving site comprises at least one reversible connecting means arranged so as to cooperate with at least one connecting means of at least one IEC, said step of forming and assembling the row or the layer of IECs over the paving consists in interlocking at least one connecting means of each of the IECs of the row or layer with at least one reversible connecting means of a different receiving site.

13. The method according to claim 12, comprising the step of individually storing the IECs, per row or per layer, and temporarily, prior to the assembly of the IECs or during the assembly of the IECs, over the paving.

14. The method according to one claim 10, comprising the step of handling and transporting the IECs by the robotic system, said step of handling and transporting further comprising coupling, successively and reversibly, at least one connecting means of an IEC with at least one reversible coupling means of the robotic system.

15. The method according to claim 11, comprising a step of disassembling all or part of the IECs composing the single-piece transformable structure manufactured or being manufactured or all or part of a row and/or of a layer of IECs by separating a considered IEC from one or more of the adjacent IECs with which the considered IEC is connected by disengaging the one or more connecting mean(s) of the considered IEC from the one or more connecting mean(s) of the adjacent IECs with which the one or more connecting mean(s) of the considered IEC cooperate by interlocking.

16. The method according to claim 10, comprising the steps of:
selecting, in a database:
one or more individual IECs having different spatial conformations and/or comprising or consisting of different materials, and/or
one or more subset(s) of IECs among subsets of IECs having different spatial conformations and/or subsets of IECs comprising or consisting of different materials,
determining, from the selected individual IECs and/or the selected subsets, one or more arrangement(s) of the selected individual IECs and/or of the subsets with respect to one another in the transformable structure so that the application of the at least one stimulus results in the modification of at least one property of the transformable structure.
